(19) United States
(12) Patent Application Publication
(10) Pub. No.: US 2023/0250035 A1
(43) Pub. Date: Aug. 10, 2023

(54) SYNTHESIS AND APPLICATION OF DILTIAZEM HYDROCHLORIDE

(71) Applicants: Guiyang PENG, Haikou City, Hainan (CN); HAINAN DENDROBIUM HEALTH INDUSTRY CO.,LTD., Haikou City, Hainan (CN)

(72) Inventors: Guiyang PENG, Haikou City, Hainan (CN); Xiangming NING, Haikou City, Hainan (CN); Wu LI, Haikou City, Hainan (CN); Wanxing ZHANG, Haikou City, Hainan (CN); Xiaoping CHEN, Haikou City, Hainan (CN); Haisong FU, Haikou City, Hainan (CN); Guobing WU, Haikou City, Hainan (CN); Wei DENG, Haikou City, Hainan (CN)

(21) Appl. No.: 17/624,278

(22) PCT Filed: Dec. 27, 2021
(86) PCT No.: PCT/CN2021/141701

§ 371 Date: Dec. 31, 2021

(30) Foreign Application Priority Data
Jan. 8, 2021 (CN) 202110022588.0

(51) Int. Cl. C05F 3/00; C05G 3/60

(52) U.S. Cl. CPC C05F 3/00; C05G 3/60

(57) ABSTRACT

A processing method of Dendrobium organic fertilizer, which comprises the following steps: Step 1: select 4-6 parts by weight of rotten animal dung; Step 2: add 0.5-1.5 parts by weight of disinfectant to animal dung; Step 3: add disinfectant to dung and let it stand for 1-3 hours; Step 4. uniformly mixing to obtain organic fertilizer. The invention controls the viscosity of animal dung within a range, thereby improving the adhesion between animal dung and Dendrobium, slowing down the drying and hardening speed of animal dung, moisturizing the roots, sterilizing animal dung and reducing the probability of affecting the growth of Dendrobium.

### FIELD OF THE INVENTION

The application relates to the technical field of organic fertilizer processing, in particular to a processing method of Dendrobium organic fertilizer.

### BACKGROUND OF THE INVENTION

Dendrobium is a common and precious traditional Chinese medicine. Dendrobium is used as medicine with its stem. It is cold in nature and sweet in taste. It has the effects of benefiting the stomach, generating fluid, nourishing yin and clearing heat. It can be used for treating fever, thirst, asthenic heat after illness, scanty tongue fur, scanty food, retching, blurred vision, etc. The common method of artificial cultivation of Dendrobium is stick tree cultivation. When stick tree cultivation is used, it is necessary to cut a shallow crack on the flat and thick branch or trunk with a knife, then fix the base of the treated Dendrobium at the crack with bamboo nails or ropes, and then apply rotten animal dung to is the root of Dendrobium. When the applied animal dung is too wet, it is easy to fall from the root of Dendrobium under the action of gravity, the adhesion is not high, the root of Dendrobium causes waste, and Dendrobium can not absorb nutrition. When the applied animal dung is too dry, the drying and hardening speed of animal dung is accelerated, which can not keep water and moisture for a period of time, and there are a large number of harmful bacteria in animal dung, if it is applied directly without treatment, it will affect the growth of Dendrobium.

### DETAILED DESCRIPTION OF THE INVENTION

The application provides a processing method of Dendrobium organic fertilizer, which controls the viscosity of animal dung within a range, so as to improve the adhesion between animal dung and Dendrobium, slow down the drying and hardening speed of animal dung, protect and moisturize the roots, sterilize animal dung and reduce the probability of affecting the growth of Dendrobium.

In order to solve the above problems, the technical scheme adopted by the invention is as follows: The invention provides a processing method of Dendrobium organic fertilizer, the processing method is:

Step 1) select 4-6 parts by weight of rotten animal dung;

Step 2) add 0.5-1.5 parts by weight of disinfectant to animal dung;

Step 3) add disinfectant to dung and let it stand for 1-3 hours;

Step 4) mix evenly to obtain organic fertilizer.

As another limitation of the invention, the weight of the animal dung is 5 parts, and the weight of the disinfectant is 1 part.

As another limitation of the invention, in step 2, the disinfectant is potassium permanganate diluted 1000 times.

As another limitation of the invention, in step 3, the standing time is 2 hours.

As another limitation of the invention, in step 1, the animal dung is cow dung.

As another limitation of the invention, it also includes step 5, separate loading the organic fertilizer into sealed container.

As another limitation of the invention, In step 5, the container used is an applicator, which comprises a hollow cylinder, a cylindrical piston and a piston shaft; The bottom end of the cylinder is provided with a discharge port for applying organic fertilizer; The top of the cylinder is provided with a feed port for loading organic fertilizer, the piston is arranged close to the inner wall of the cylinder, and the piston shaft is fixedly connected with the top of the piston and slidably connected with the cylinder through the piston.

As another limitation of the invention, the bottom end of the cylinder is located on one side of the discharge port, and an extrusion with the same height as the discharge port is connected.

As another limitation of the invention, the extrusion part is a brush.

As another limitation of the invention, a scale mark is arranged on the side wall of the cylinder.

The Benefit is:

Mix a certain proportion of animal dung with a certain proportion of disinfectant after standing. The disinfectant softens the animal dung before mixing, which effectively improves the mixing uniformity of animal dung and disinfectant. When disinfecting the harmful bacteria in animal dung, the organic fertilizer can neither form a mass nor a water flow, It is not easy to fall down when applied on the root of Dendrobium. It closely adheres to the root of Dendrobium, thus slowing down the drying speed of the organic fertilizer. Make the internal moisture evaporate slowly, and keep a certain humidity for a period of time. Therefore, when the root of Dendrobium is wrapped, it plays the role of water and moisture conservation for the root of Dendrobium, provides a good growth environment for Dendrobium and promotes the growth and development of Dendrobium.

### THE APPENDED DRAWINGS SHOW

The invention is described in more detail below in combination with the accompanying drawings and specific examples.

FIG. 1 is a flowchart of a processing method of Dendrobium organic fertilizer provided by the invention;

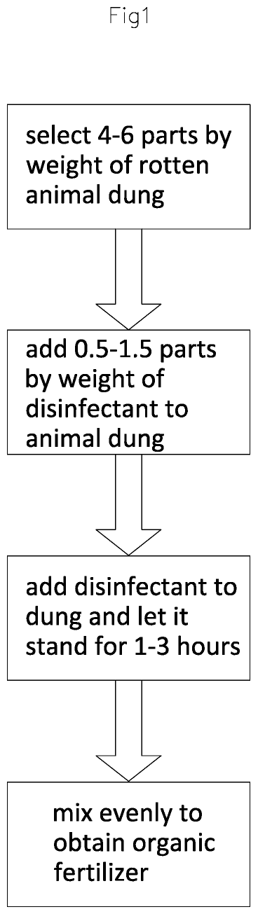

FIG. 2 is structural diagram of applicator.

### EXAMPLES

is A preferred example of the present invention is described below in combination with the accompanying drawings. It should be understood that the preferred examples described herein are only used to illustrate and understand the invention and are not used to limit the invention.

### Example 1

A method for processing Dendrobium organic fertilizer, comprising:

Step 1, select 5 kg of rotten dry cow dung and put it into the bucket;

Step 2, then add 1 kg of potassium permanganate diluted 1000 times to the bucket to prevent the root rot of Dendrobium from being caused by too high concentration.

Step 3, stand for 2 hours to make the potassium permanganate solution completely immersed in cow dung, soften dry cow dung and kill bacteria or fungi in cow dung;

Step 4. Use a mixer to evenly mix the dry cow dung and potassium permanganate to obtain organic fertilizer. The mixing time is 8 minutes. Specifically, Use the mixer to insert it into the cow dung bucket first (avoid throwing the cow dung on the surface around by the high-speed rotating mixing rod). At the beginning, the resistance is relatively large. Depending on the situation, some potassium permanganate solution can be added to dilute the cow dung. When the cow dung is too thin, dry cow dung can be added to absorb some water;

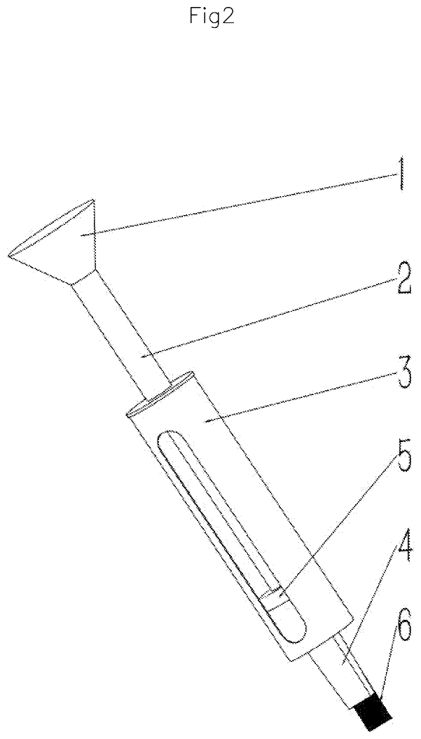

Step 5. For the sake of understanding, please refer to FIG. 2, the organic is fertilizer obtained after uniform mixing is sub packed into a sealed container. The sealed container can reduce the reduction of water content of the organic fertilizer, so as to slow down the drying speed of the organic fertilizer, prolong the placement time of the organic fertilizer, and avoid that the mixed organic fertilizer is easy to dry after being placed for a long time, and has to be re mixed when it is needed later, It increases a certain workload. Preferably, the sealed container is an applicator. The applicator can be used to preserve organic fertilizer and apply organic fertilizer to Dendrobium, which is convenient and simple. It does not need to apply organic fertilizer manually, which reduces the discomfort of artificial smell and improves the work efficiency of artificial. The applicator includes hollow cylinder 3 Cylindrical piston 5 and piston shaft 2; The bottom end of the barrel 3 is provided with a discharge port 4 for applying organic fertilizer. The discharge port 4 is a pyramid extending downward and the outlet is flat. Preferably, in order to form a sealed environment inside the barrel 3, an openable sealing rubber cover is arranged at the bottom of the discharge port 4 when the application device is not in use to control the opening and closing state of the discharge port 4, Thus, the internal state of the cylinder 3 is controlled. The top of the cylinder 3 is provided with a feed port for loading organic fertilizer, the piston 5 is arranged close to the inner wall of the cylinder 3, the piston shaft 2 is fixedly connected with the top of the piston 5 and slidably connected with the cylinder 3 through the piston 5, that is, the piston 5 can be pushed towards the bottom of the cylinder 3 under the push-pull action of the piston shaft 2, The organic fertilizer in the cylinder 3 is squeezed out from the discharge port 4, and the piston 5 can be pulled out and pulled out of the cylinder 3, so that the top of the cylinder 3 is an open structure and loaded with organic fertilizer, which can close the cylinder 3 and squeeze the organic fertilizer out of the cylinder 3. Preferably, for the convenience of pushing and pulling, a round table 1 with an area larger than the piston shaft 2 can be set at the top of the piston shaft 2.

The bottom end of the barrel 3 is located on one side of the discharge port 4, and an extrusion 6 with the same height as the discharge port 4 is connected. When organic fertilizer is applied to the root of Dendrobium from the discharge port 4, due to the low adhesion between the organic fertilizer applied to the root of Dendrobium from the barrel 3 and Dendrobium, it is easy to fall down, so it is necessary to apply a certain pressure on the organic fertilizer, The extrusion is preferably a brush, which can increase the application area of organic fertilizer, that is, when the organic fertilizer from the cylinder 3 is applied to the root of Dendrobium, the organic fertilizer applied on it has a certain thickness, and the organic fertilizer with a certain thickness is spread out under the action of the brush, So as to increase the application area and reduce the use of organic fertilizer, which can save a certain amount of organic fertilizer and avoid waste of resources. The cylinder 3 is provided with a scale line, which can be installed t at the corresponding scale line position according to the required amount of organic fertilizer, so as to facilitate manual operation and avoid the waste of time is when the required amount of organic fertilizer is not enough and needs to be taken back and forth manually.

By mixing 5 kg cow dung with 1 kg diluted 1000 times potassium permanganate solution to make organic fertilizer, potassium permanganate softens the cow dung before mixing, which effectively improves the integration degree of potassium permanganate into cow dung, so as to improve the mixing uniformity of cow dung and potassium permanganate solution, When the harmful bacteria in the cow dung are disinfected, the cow dung can be made into neither a mass nor a water flow, so that the organic fertilizer is not easy to fall down when applied on the Dendrobium root, the adhesion is improved, the drying speed of the organic fertilizer is slowed down, the internal water evaporation is slowed down, and a certain humidity is maintained for a period of time, so as to keep the water and moisture of the Dendrobium root, Provide a good growth environment for Dendrobium and promote the growth and development of Dendrobium. The organic fertilizer can also be put into the sealed applicator. On the one hand, the organic fertilizer can be stored when not in use to reduce the water evaporation in the organic fertilizer and prolong the storage time of the organic fertilizer. On the other hand, when the organic fertilizer is used, the organic fertilizer can be directly squeezed and applied from the applicator to the root of Dendrobium, which is hygienic and efficient, Reduce artificial discomfort and improve workers' work efficiency.

### Example 2

A method for processing Dendrobium organic fertilizer, comprising:

Step 1, Select 4 kg of rotten dry cow dung and put it into the bucket;

Step 2, then add 0.5 kg potassium permanganate diluted 1000 times into the bucket to prevent excessive concentration from causing root rot of Dendrobium.

Step 3, stand for 2 hours to make the potassium permanganate solution completely immersed in cow dung, soften dry cow dung and kill bacteria or fungi in cow dung;

Step 4, use a mixer to evenly mix the dry cow dung and potassium permanganate to obtain organic fertilizer. The mixing time is 8 minutes. Specifically, Use the mixer to insert it into the cow dung bucket first (avoid throwing the cow dung on the surface around by the high-speed rotating mixing rod). At the beginning, the resistance is relatively large. Depending on the situation, some potassium permanganate solution can be added to dilute the cow dung. When the cow dung is too thin, dry cow dung can be added to absorb some water;

Step 5, for ease of understanding, please refer to FIG. 2. Pack the organic fertilizer obtained after mixing evenly into a sealed container. The sealed container can reduce the reduction of water content of organic fertilizer, so as to slow down the drying speed of organic fertilizer, prolong the placement time of organic fertilizer, and avoid that the mixed organic fertilizer is easy to dry after being placed for a long time. When it needs to be used later, it has to be remixed, It increases a certain workload. Preferably, the sealed container is an applicator. The applicator can be used to preserve organic fertilizer and apply organic fertilizer to Dendrobium, which is convenient and simple. It does not need to apply organic fertilizer manually, which reduces the discomfort of artificial smell and improves the work efficiency of artificial. The applicator includes hollow cylinder 3 Cylindrical piston 5 and piston shaft 2; The bottom end of the barrel 3 is provided with a discharge port 4 for applying organic fertilizer. The discharge port 4 is a pyramid extending downward and the outlet is flat. Preferably, in order to form a sealed environment inside the barrel 3, an openable sealing rubber cover is arranged at the bottom of the discharge port 4 when the application device is not in use to control the opening and closing state of the discharge port 4, Thus, the internal state of the cylinder 3 is controlled. The top of the cylinder 3 is provided with a feed port for loading organic fertilizer, the piston 5 is arranged close to the inner wall of the cylinder 3, the piston shaft 2 is fixedly connected with the top of the piston 5 and slidably connected with the cylinder 3 through the piston 5, that is, the piston 5 can be pushed towards the bottom of the cylinder 3 under the push-pull action of the piston shaft 2, The organic fertilizer in the cylinder 3 is squeezed out from the discharge port 4, and the piston 5 can be pulled out and pulled out of the cylinder 3, so that the top of the cylinder 3 is an open structure and loaded with organic fertilizer, which can close the cylinder 3 and squeeze the organic fertilizer out of the cylinder 3. Preferably, for the convenience of pushing and pulling, a round table 1 with an area larger than the piston shaft 2 can be set at the top of the piston shaft 2.

The bottom end of the barrel 3 is located on one side of the discharge port 4, and an extrusion 6 with the same height as the discharge port 4 is connected. When organic fertilizer is applied to the root of Dendrobium from the discharge port 4, due to the low adhesion between the organic fertilizer applied to the root of Dendrobium from the barrel 3 and Dendrobium, it is easy to fall down, so it is necessary to apply a certain pressure on the organic fertilizer, The extrusion is preferably a brush, which can increase the application area of organic fertilizer, that is, when the organic fertilizer from the cylinder 3 is applied to the root of Dendrobium, the organic fertilizer applied on it has a certain thickness, and the organic fertilizer with a certain thickness is spread out under the action of the brush, So as to increase the application area and reduce the use of organic fertilizer, which can save a certain amount of organic fertilizer and avoid waste of resources. The cylinder 3 is provided with a scale line, which can be installed to its corresponding scale line position according to the required amount of organic fertilizer, so as to facilitate manual operation and avoid the waste of time when the required amount of organic fertilizer is not enough and needs to be taken back and forth manually.

Compared with example 1, in this example, 4 kg cow dung and 0.5 kg diluted 1000 times potassium permanganate solution are mixed after standing. The mixed organic fertilizer is drier than the organic fertilizer in example 1. The organic fertilizer is in a mass and is not easy to wipe off, and the organic fertilizer is after wiping off is easy to dry, which is not conducive to water retention and moisture retention of the roots of Dendrobium, When installed in the applicator, it is not easy to squeeze out, which is laborious and inconvenient to use.

### Example 3

A method for processing Dendrobium organic fertilizer, comprising:

Step 1, Selecting 6 kg rotten dry cow dung and putting it into a bucket;

Step 2, then add 1.5 kg potassium permanganate diluted 1000 times into the bucket to prevent the root rot of Dendrobium due to high concentration.

Step 3, let it stand for 2 hours to make the potassium permanganate solution completely immersed in cow dung, soften dry cow dung and kill bacteria or fungi in cow dung;

Step 4, use a mixer to evenly mix the dry cow dung and potassium permanganate to obtain organic fertilizer. The mixing time is 8 minutes. Specifically, Use the mixer to insert it into the cow dung bucket first (avoid throwing the cow dung on the surface around by the high-speed rotating mixing rod). At the beginning, the resistance is relatively large. Depending on the situation, some potassium permanganate solution can be added to dilute the cow dung. When the cow dung is too thin, dry cow dung can be added to absorb some water;

Step 5, for ease of understanding, please refer to FIG. 2. Pack the organic fertilizer obtained after mixing evenly into a sealed container. The sealed container can reduce the reduction of water content of organic fertilizer, so as to is slow down the drying speed of organic fertilizer, prolong the placement time of organic fertilizer, and avoid that the mixed organic fertilizer is easy to dry after being placed for a long time. When it needs to be used later, it has to be remixed, It increases a certain workload. Preferably, the sealed container is an applicator. The applicator can be used to preserve organic fertilizer and apply organic fertilizer to Dendrobium, which is convenient and simple. It does not need to apply organic fertilizer manually, which reduces the discomfort of artificial smell and improves the work efficiency of artificial. The applicator includes hollow cylinder 3 Cylindrical piston 5 and piston shaft 2; The bottom end of the barrel 3 is provided with a discharge port 4 for applying organic fertilizer. The discharge port 4 is a pyramid extending downward and the outlet is flat. Preferably, in order to form a sealed environment inside the barrel 3, an openable sealing rubber cover is arranged at the bottom of the discharge port 4 when the application device is not in use to control the opening and closing state of the discharge port 4, Thus, the internal state of the cylinder 3 is controlled. The top of the cylinder 3 is provided with a feed port for loading organic fertilizer, the piston 5 is arranged close to the inner wall of the cylinder 3, the piston shaft 2 is fixedly connected with the top of the piston 5 and slidably connected with the cylinder 3 through the piston 5, that is, the piston 5 can be pushed towards the bottom of the cylinder 3 under the push-pull action of the piston shaft 2, The organic fertilizer in the cylinder 3 is squeezed out from the discharge port 4, and the piston 5 can be pulled out and pulled out of the cylinder 3, so that the top of is the cylinder 3 is an open structure and loaded with organic fertilizer, which can close the cylinder 3 and squeeze the organic fertilizer out of the cylinder 3. Preferably, for the convenience of pushing and pulling, a round table 1 with an area larger than the piston shaft 2 can be set at the top of the piston shaft 2.

The bottom end of the barrel 3 is located on one side of the discharge port 4, and an extrusion 6 with the same height as the discharge port 4 is connected. When organic fertilizer is applied to the root of Dendrobium from the discharge port 4, due to the low adhesion between the organic fertilizer applied to the root of Dendrobium from the barrel 3 and Dendrobium, it is easy to fall down, so it is necessary to apply a certain pressure on the organic fertilizer, The extrusion is preferably a brush, which can increase the application area of organic fertilizer, that is, when the organic fertilizer from the cylinder 3 is applied to the root of Dendrobium, the organic fertilizer applied on it has a certain thickness, and the organic fertilizer with a certain thickness is spread out under the action of the brush, So as to increase the application area and reduce the use of organic fertilizer, which can save a certain amount of organic fertilizer and avoid waste of resources. The cylinder 3 is provided with a scale line, which can be installed to its corresponding scale line position according to the required amount of organic fertilizer, so as to facilitate manual operation and avoid the waste of time when the required amount of organic fertilizer is not enough and needs to be taken back and forth manually.

Compared with example 1 and example 2, in this example, 6 kg of cow dung is mixed with 1.5 kg diluted 1000 times potassium permanganate solution after standing. The mixed organic fertilizer is thinner than example 1 and example 2. The organic fertilizer is in the form of water flow. When installed in the coating device, the organic fertilizer is easy to squeeze out in the form of water flow and is not easy to adhere to Dendrobium, and it was easy to fall down, with low fitting degree.

It should be noted that the above descriptions are only preferred embodiments of the present invention and are not intended to limit the present invention. Although the invention is described in detail with reference to the above examples, those skilled in the art can still modify the technical solutions recorded in the above examples or replace some of the technical features equally. Any modification, equivalent replacement, improvement, etc. made within the spirit and principles of the invention shall be included in the protection scope of the invention.

We claim:

1. A processing method of Dendrobium organic fertilizer, wherein the processing method is:
Step 1) select 4-6 parts by weight of rotten animal dung;
Step 2) add 0.5-1.5 parts by weight of disinfectant to animal dung;
Step 3) add disinfectant to dung and let it stand for 1-3 hours;
Step 4) Uniformly mixing to obtain organic fertilizer.

2. The method of claim 1, wherein the weight of the animal dung is 5 parts, and the weight of the disinfectant is 1 part.

3. The method of claim 1, wherein in step 2, the disinfectant is potassium permanganate diluted 1000 times.

4. The method of claim 1, wherein in step 3, the standing time is 2 hours.

5. The method of claim 1, wherein in step 1, the animal dung is cow dung.

6. The method of claim 1, wherein it also includes step 5, separate loading the organic fertilizer into sealed container.

7. The method of claim 6, wherein in step 5, the used container is an applicator, which comprises a hollow cylinder, a cylindrical piston and a piston shaft; The bottom end of the cylinder is provided with a discharge port for applying organic fertilizer; The top of the cylinder is provided with a feed port for loading organic fertilizer, the piston is arranged close to the inner wall of the cylinder, and the piston shaft is fixedly connected with the top of the piston and slidably connected with the cylinder through the piston.

8. The method of claim 7, wherein the bottom end of the cylinder is located on one side of the discharge port, and an extrusion with the same height as the discharge port is connected.

9. The method of claim 8, wherein the extrusion part is a brush.

10. The method of claim 7, wherein a scale mark is arranged on the side wall of the cylinder.
